(19) United States
(12) Patent Application Publication
(10) Pub. No.: US 2012/0232989 A1
(43) Pub. Date: Sep. 13, 2012

(54) METHOD AND APPARATUS FOR CONVERSATION TARGETING

(75) Inventor: Timothy A. Musgrove, Morgan Hill, CA (US)

(73) Assignee: FEDERATED MEDIA PUBLISHING, INC., San Jose, CA (US)

(21) Appl. No.: 13/414,248

(22) Filed: Mar. 7, 2012

Related U.S. Application Data
(60) Provisional application No. 61/449,922, filed on Mar. 7, 2011.

(51) Int. Cl. G06Q 30/02

(52) U.S. Cl. 705/14.49

(57) ABSTRACT

The disclosed embodiments relate to a method, apparatus, and non-transitory computer-readable medium for placing content in conversations. An exemplary method comprises determining intersecting data based on a conversation data and marketing data, the marketing data being associated with content that is adapted for placement relative to one or more conversations, and creating a conversational model based on the intersecting data, the conversational model including data that is relevant to both the conversation data and the marketing data, wherein the conversational model is adapted to be used to place the content relative to at least one of the one or more conversations.

### RELATED APPLICATION DATA

This application claims priority in U.S. Provisional Application No. 61/449,922, filed Mar. 7, 2011, which is hereby incorporated by reference in its entirety.

### FIELD OF THE INVENTION

The invention relates to a method and apparatus for conversation targeting.

### SUMMARY

The disclosed embodiment relates to a computer-implemented method executed by one or more computing devices for placing content in conversations. An exemplary method comprises determining, by at least one of the one or more computing devices, intersecting data based on a conversation data and marketing data, the marketing data being associated with content that is adapted for placement relative to one or more conversations, and creating, by at least one of the one or more computing devices, a conversational model based on the intersecting data, the conversational model including data that is relevant to both the conversation data and the marketing data, wherein the conversational model is adapted to be used to place the content relative to at least one of the one or more conversations.

The disclosed embodiment further relates to an apparatus for placing content in conversations. An exemplary apparatus comprises one or more processors; and one or more memories operatively coupled to at least one of the one or more processors and storing instructions that, when executed by at least one of the one or more processors, cause at least one of the one or more processors to determine intersecting data based on a conversation data and marketing data, the marketing data being associated with content that is adapted for placement relative to one or more conversations; and create a conversational model based on the intersecting data, the conversational model including data that is relevant to both the conversation data and the marketing data, wherein the conversational model is adapted to be used to place the content relative to at least one of the one or more conversations.

The disclosed embodiment also relates to at least one non-transitory computer-readable medium storing computer-readable instructions that, when executed by one or more computing devices, place content in conversations, the instructions causing at least one of the one or more computing devices to determine intersecting data based on a conversation data and marketing data, the marketing data being associated with content that is adapted for placement relative to one or more conversations; and create a conversational model based on the intersecting data, the conversational model including data that is relevant to both the conversation data and the marketing data, wherein the conversational model is adapted to be used to place the content relative to at least one of the one or more conversations.

As described herein, the conversation data may include data from a webpage, one or more predictor influencers may contribute to the conversation data, one or more conversation topics may be identified from within the conversation data, one or more aspects of at least one of the one or more conversation topics may be identified, and the marketing data may includes marketing collateral.

The disclosed embodiment further relates to a computer-implemented method executed by one or more computing devices for placing content on a webpage. An exemplary method comprises creating one or more conversation tags corresponding to a conversation on a webpage, determining content for placement relative to the conversation based at least one of the conversation tags, and placing the content on the webpage relative to the conversation. The method may include analyzing the conversation and another conversation. The method may also include transmitting information related to at least one of the conversation, the conversation tags, the content, and the webpage. The content: may be associated with at least one of a promoted comment, an advertisement, and a widget, may correspond to marketing collateral, and may correspond to one or more products or services.

### BRIEF DESCRIPTION OF THE DRAWINGS

FIG. 1 illustrates an exemplary workflow related to the use of a conversation analyzer according to the disclosed embodiment.

FIG. 2 illustrates an exemplary workflow according to the disclosed embodiment in which aspects are extracted from a plurality of conversation topics.

FIG. 3 illustrates an exemplary placement of content according to the disclosed embodiment.

FIG. 4 illustrates an exemplary computing device according to the disclosed embodiment.

### DETAILED DESCRIPTION

Attempts today to target ads or other content at web pages are bound to face certain pitfalls, owing largely to the fact that the Web is becoming more conversational, and conversations by their very nature are under-determined by topic and keyword tagging techniques. Natural conversations combine multiple topics; achieve their character by adding certain emphases and attitudinal alignments; tend to move fluidly from one topic to another; exhibit peaks and valleys of activity which result in it being “too late” to target a conversation by the time most detection methods have determined that it is important (the conversation has started to die down by the time the advertiser realizes it is worth targeting). Known methods of targeting fait to address most or all of these essential features of conversations.

However, by enriching the model of what a conversation is, and building appropriate methods on top of such a model, better prediction of conversation patterns, more precise and timely targeting of ads to conversations, and even bidirectional targeting of ads to conversations can be achieved.

Ad targeting, or the attempt to place ads into contexts to which they are relevant, is a mainstay of online advertising today. Google's AdSense and AdWords are paradigmatic examples, but were developed in the “Web 1.0” era, i.e., before user generated content, blogging, and micro-blogging made the Web take on a conversational model more than a publishing model. Marketers therefore have been looking for other methods to enter the “Social Web.” BuzzLogic, since 2006, has offered a “conversational targeting” service that revolves around “influencers” (chiefly Hogs) within a certain topic or on a certain keyword. The advertising is then targeted toward the most influential blogs within that topic. (See “http://www.marketingvox.com/buzziogic-gets-into-ad-er-conversation-targetin 034289”).

Also, BuzzLogic has enhanced its service by allowing the advertiser to present more “conversational” elements within an ad unit, thus hoping to spark a relevant conversation via the ad itself. (See “http://www.emediavitals.com/article/1005/buzzlogic-aims-make-blog-ads-more-engaging-and-more-protitable”). More recently, OneRiot has offered “conversational targeting” in the sense of reaching into micro-blogging applications such as CiberTwitter and Seesmic, and, for example, delivering a SuperBowl ad to users “who are conversing about the SuperBowl right now.” (See “http://www.adexchanger.com/ad-networks/oneriot”).

The existing methods noted above do not address the more essential aspects of a conversation, i.e., things which make conversation actually conversational rather than a lecture or a soliloquy, such as dialectic (going back and forth between point and counter-point to finally reach a higher or intermediate point), fluidity (flowing step by step from one related theme to another until the topic is quite different from when it started), polemic (rhetoric that is convincing only to the already-convinced, e.g., “preaching to the choir”), ideology (purporting to neutrality while bearing a clear bias), or many other elements that are hallmarks of conversations. Some of these elements may seem fairly intangible, and indeed, it is simply not possible to entirely capture these elements with machine methods today. Yet, without at least some partial grasp of them, any service calling itself “conversation targeting” is largely just topic-targeting or chatter-targeting.

Lack of a genuine conversation targeting method has the potential to yield the many undesirable results, such as the following.

Marketers may see their ads placed where a topic or keyword is present but the thrust of the conversation is irrelevant. For example, suppose an arthritis drug maker wants their ad placed wherever arthritis is discussed. An ad may be seen on a fibromyalgia forum, which unmistakably mentions arthritis several times, but only includes complaints that an arthritis drug prescribed for fibromyalgia patients “didn't work”, “was useless”, etc.

Marketers may see their ads placed on pages that bear a certain topic, but with a slant or emphasis that is not at all germane. For example, suppose BestBuy wants a certain ad placed only in blogs where their name is mentioned positively, but the add may be seen next to a negative comment phrased as: “Don't you just love how BestBuy only hires idiots,” A simplistic spotting of “loves” fooled the targeting system.

Marketers fait to get their ad onto pages where it should be, because the topic designation does not seem to fit. For example, suppose HP wants its new tablet advertised on tech Hogs. However, a section of a parenting blog contains good dialog from parents discussing how the HP tablet, when loaded with special apps for kids, made their long car trips much easier. This Hog sadly lacks the HP ad.

Marketers fail to get their ad onto hot conversational pages where the inventory is sold out, because they did not know the topic would be hot until it was too late. For example, suppose Sony finds out that a new study, suggesting that long term viewing of 3D television could have ill health effects, has exploded in discussions across the Web. They want to get ads placed that carry a counter-message. But they can't, because scores of other marketers already got similar reports and bought up all the ad inventory space already.

Marketers get the right product slated against the right conversation at the right time, but with the wrong value proposition, because the nature of the conversation was not captured. For example, suppose an arthritis drug maker gets the ad for their product, bragging about how fast-acting it is, placed against Hogs that are indeed pulsing with conversation about arthritis remedies, but they don't get click-through. This is because the hot conversation at the time is around drug side effects. Meanwhile, the drug maker possesses marketing creative explaining how their drug has low side effects, but none of this was used in the ad campaign.

Marketers get perfect targeting of their ad to a rather long conversational web page, and are happy that it is “above the fold” (a covetable position), but the ad doesn't feel relevant to the user while reading the page, because the part of the page to which it is relevant is much further down. For example, suppose a sports discussion starts on a 49ers blog about the NFL lock-out, then users begin a trail of comments about the mistakes they think the owners'and players' union is making, then the discussion turns to a comparison to the similar crisis Major League Baseball had several years earlier. The ad, pitching a new series on HBO about the history of the MLB is strongly relevant here, but is many lines below the fold.

Many other examples exist illustrating the disadvantages of the existing systems. Thus, there clearly is a need within the industry for (1) characterizing a conversation in a richer way than just mapping it to a topic, (2) detecting when a conversation is beginning to build intensity before it is already mostly over, (3) know just the spot in a page to which an ad is relevant and (4) finding which MarCom material is relevant to the conversation rather than just the other way around. The present invention addresses these concerns and others, while establishing a more robust framework for modeling, discovering, predicting, and matching online conversations and marketing content.

For example, the disclosed embodiments relate to a method and apparatus for the identification of essential aspects of a conversation for the purpose of content targeting based on the conversation. The systems of the embodiment target conversations rather than keywords. The term “conversation” as described herein preferably refers to topics that are being actively engaged by users. For example, an exemplary conversation regarding “tablet apps” could refer to the combination of topics, such as “Apple iPad,” “Samsung Galaxy Tab,” “HP Slate,” etc., and activity on related websites, such as BoingBoing. CoolMomTech.com, etc., related to “tablet apps.” The resulting conversation thus includes not just topics or activity, but a combination of both.

Conversations are a much better source for targeting than keywords. Keywords can lead to substantial ambiguity. (i.e. “App” can mean something irrelevant, i.e. it can be short for “appliance” or it can mean a “job application”). For example, the phrase “I hear Apple's getting lots of job apps for iPad developers in Cupertino” is not a good match for “tablet apps” content. In addition, the use of wording can vary greatly. (i.e. “Game” could be referenced in different forms, and lots of different slang abbreviations, nicknames, etc. can be present.) For example, the phrase “download this third-person shooter on your Gal Tab, it rocks” is a good match for “tablet apps” but would not have been identified using just the word “game” or “app,” Furthermore, by considering user activity across the web, the most vibrant and active discussions can be utilized.

Emergent conversation topics are determined from “predictor influencers” as opposed to “christening influencers”. An “influencer” on the Web is typically thought to be someone who has many thousands of Twitter followers, and whose posts get tweeted and re-tweeted and Facebook-Liked a lot, and so on. What is interesting, however, is that in most cases, the first post on a certain topic by an influencer is not the first time it was posted about. Rather, the topic was often written about earlier by a less “influential” blogger. This means that the so-called “influencer” really was christening the topic, as it were, while he or she was actually not the best predictor of it. As a result, the word “influencer” often has been applied in too narrow a sense in the tech industry. In actuality, there are two kinds of relevant influencers: predictors and christeners. By making this distinction, various concerns around both discovering and predicting conversations can be addresses. When a blogger (or a blog site) is known to be a good predictor (as opposed to a christener), and when multiple such predictors are at once predicting the same, not-yet-christened topic as being important, there is a strong correlation to an uptick in the conversational activity. The following example supports and illustrates this finding. As of this writing, GigaOM has 34,362 followers on Twitter. This is a high number compared to the average person, but it is paltry compared to TechCrunch (a competitor to GigaOM in the blogosphere), which has 1,588,739. Yet on a random sample of 30 “spiking topics” which were tweeted by both, GigaOM was the first to tweet on 22 of them, whereas TechCrunch was the first on only 8, and the average time gap was more than four hours, in favor of GigaOM being earlier. This means that the one with the higher “influence” number is actually far from being the better predictor of the two.

The identifying conversation topics described above can then be analyzed against those derived from advertisers' marketing collateral to determine feature intersections of the two. Marketing collateral, in marketing and sales, refers to the collection of media used to support the sales of a product or service. These sales aids are intended to make the sales effort easier and more effective. The brand of a company usually presents itself by way of its collateral to enhance its brand. The production of marketing collateral is important in any business marketing communication plan. Marketing collateral differs from advertising in that it is typically used later in the sales cycle, usually when a prospective purchaser has been identified and sales staff are making contact with them. Next, new clusters of features with commonality to the two clusters derived from predictors and from marketing materials, but not necessarily being identical to either one alone, are identified or constructed. The new dusters may be weighted, as needed, to indicate importance of certain features. This last step has the potential to create a new conversation model/topic-cluster that is useful for the identification, creation and placement of relevant advertising content.

Examining more features of content than just the topic, and examining more features of the conversational activity than just views and shares, while using a different model of influence that is more about predicting a topic will be hot rather than christening it as already important, are the chief building blocks of the system. Based upon these, bidirectional targeting can be executed rather than unidirectional targeting, which results in a cyclic rather than acyclic targeting graph. This means that rather than merely targeting ads to content, the advertiser can also be prompted to compose more relevant content to match to conversations, or the system may automatically pull out existing creative that is more relevant to a conversation.

According to the disclosed embodiment, to have a richer view of the content of a conversation, many features can be extracted. This extraction can include, for example, tags relating to subject matter (topic or keyword), named entity (proper name), attribute (quality, relation, etc.), function (activity, change, cause, effect), slant (ideological position, attitude, outlook), sentiment (emotion, like/dislike, approval/disapproval), and the like.

In addition, many features related to social activity and influence can be examined. Exemplary features include: the likelihood of getting thoughtful, commentary-style tweets about a Hog post rather than just default, low-effort, single-click tweeting of the post; the likelihood of getting back-and-forth commentary on the post from users rather than all commentators making one-and-done comments; the presence of secondary-engagement indicators showing more than a fleeting involvement in the topic by users; the capacity of the blogger to “influence the influencers” or predict important topics, even if the blogger is not a big direct influencer himself or herself; the capacity of a topic, when introduced to a withering discussion thread, to re-enliven that discussion thread; the presence of other indirect indicators that a topic or a blogger on a topic is effective in changing the conversation pattern, even if the popularity thereof has not yet peaked, and the like.

Based on the foregoing, the system of the disclosed embodiment can utilize not only topic and tagging technologies, but can also supplement these with other “aspects” which can include sentiment, “slant” and other feature extractions, and all the types of social engagement measures outlined above, to perform clustering of such features, so as to determine emergent topics among (a) the social networks and the independent Web, (b) the marketer's collateral materials and ad copy collection, and (c) the intersection of the former.

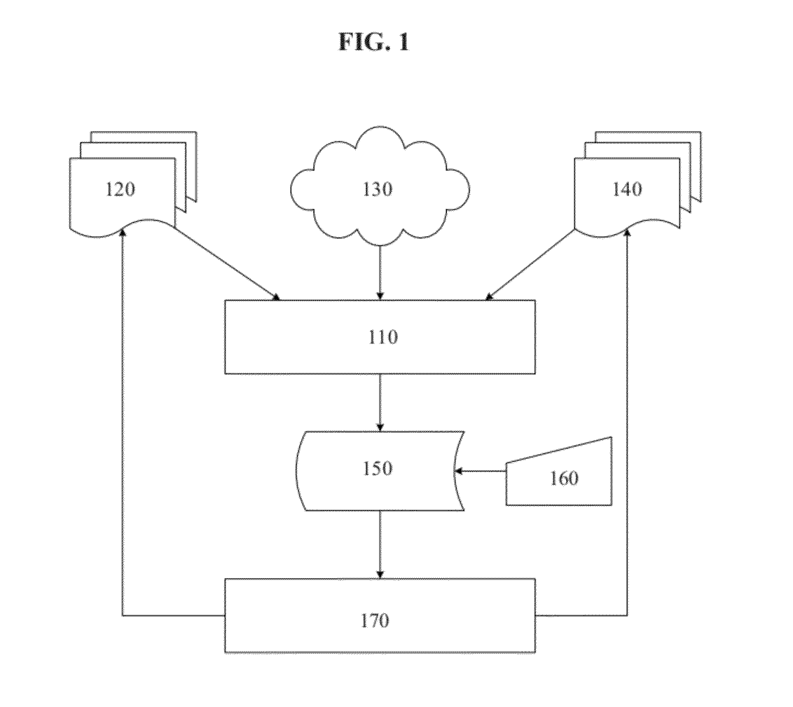

FIG. 1 illustrates an exemplary workflow according to the disclosed embodiment. A conversation analyzer 110 can analyze and interpret data collected from a variety of sources. These sources include, for example, content from online sources 120, such as social web sources, content from 3^{rd} party metrics and other web data 130, content from a database 140 or other storage source that includes prior analytics obtained through the disclosed embodiment, and the like. After analyzing the data, conversation analyzer 110 outputs a conversation model 150, which can be further adjusted via editor input 160. Conversation model 150 can used by a bidirectional targeting engine 170 to output suggestions for conversation targeting relative to the online sources 120 and the database 140.

More specifically, the disclosed embodiment discloses first identifying conversations in both (a) the social networks and the independent Web and (b) the marketer's collateral materials and ad copy collection, and then finding new clusters that may absorb much of both (a) the social networks and the independent Web and (b) the marketer's collateral materials and ad copy collection, while perhaps not being identical to either one.

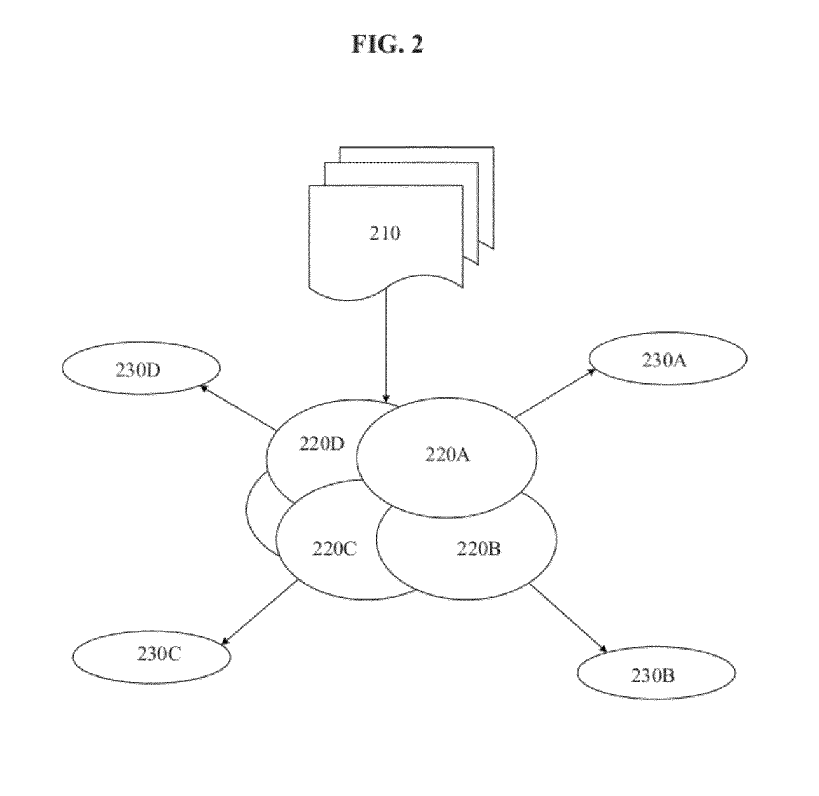

FIG. 2 illustrates an exemplary workflow in which aspects are extracted from a plurality of conversation topics. In FIG. 2, data 210, which can be obtained from a variety of sources such as social web content, as described herein, includes a large number of topics 220A-D. Based on an analysis of these topics, conversational aspects 230A-D can be extracted and identified as being relevant or important.

For example, suppose Dell has ad copy boasting their enhanced warranty coverage on laptops, for the first time covering even the battery (which is unusual in the industry). The cluster formed is that of several different ad pieces, data sheets, press releases, etc. tagged with things such as “Dell”, “laptop”, “warranty”, “replaceable battery”, etc. and various meta-data attached to such things, like the frequency of these tags, their weighted importance, evaluative language attached to them (e.g., warranty is addressed as a positive rather than a negative thing, and so on.). Meanwhile, on the social web, there is no single cluster of content that matches right away with Dell's marketing cluster. However, there is one that partly overlaps it, but scarcely mentions Dell at all, while discussing in very negative terms the over-heating and occasional melting of laptop batteries of various other brands. The meta-data here looks largely different on the surface, but it is related indirectly. Based on this information, it is clear that a certain positive thing (warranty on battery) can address a related negative thing (defect of a battery), and that it is likely that several predictor bloggers (rather than christeners) have indicated that this melting battery discussion is about to really take off.

By merging the two clusters related to (a) the social networks and the independent Web and (b) the marketer's collateral materials and ad copy collection, and examining the related meta-data again, a third conversation model can be created based on the intersection of the two clusters. The third cluster is not exactly like either of the first two clusters, but has some elements of each. For example, it may indicate Dell's brand name with greater weight than others, may focus less on all the tricks users employ to get a bit more life out of a failing battery, and may focus more on the speed of Dell's battery replacement service via express shipping, and so on. Thus, in essence, an abstract model of an intermediate conversation has been created. This model does not look quite like the existing Hog discussions, and also does not look quite like Dell's existing marketing content, but it bear a resemblance to both (i.e. it “bears a family resemblance,” in the sense of Wittgenstein and Searle in linguistic theory, to both of them).

With this new, third model, the system of the disclosed embodiment can, for example, automatically pull the relevant Dell press releases and data sheets, extract the best paragraphs or sentences therein, and place them onto the appropriate blog pages, precisely at the point on the page or at precisely the position within the discussion thread, where they would have the most effect. Meanwhile, the Dell ad copy team can be alerted so that they may optionally employ human editing to make even better ad copy, within hours or even minutes of when the conversation has been discovered by the system.

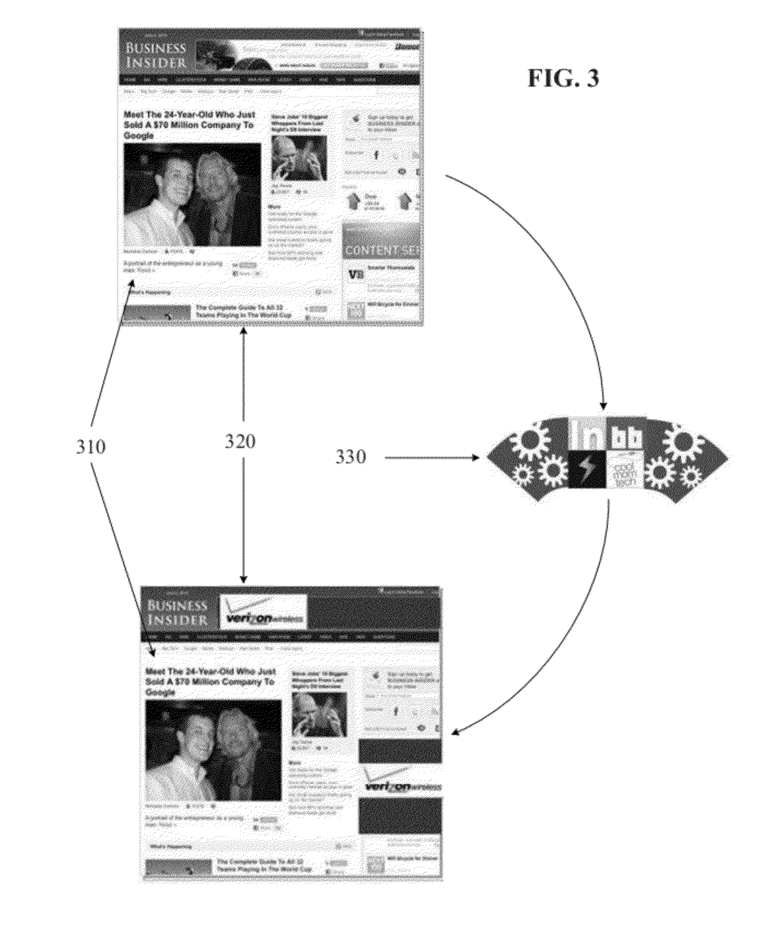

FIG. 3 illustrates exemplary placement of targeted content. In FIG. 3, an influential post 310 is posted on a webpage 320. Conversational tags 330 are created based on data collected from a variety of relevant and/or matching conversations. Using conversational tags 330, targeted advertisements 340 can be placed around post 310 on webpage 320 in an improved manner, such as framing post 310.

The benefits of using a predictive system as is disclosed herein are extensive, and include the following, for example. First, traffic BIT (“below the fold”) (i.e. down in the discussion thread), can be monetized. In addition, a kind of “thread sharing” (i.e. —establishing conversation threads across properties) can occur as the method of the disclosed embodiment is executed across a network of Hogs, instead of just one at a time. Furthermore, targeted content, such as a promoted comment, ad, widget or other sponsored material, can be added and interweave into user-generated discussions. Also, coverage gap detection and reporting can be provided to both bloggers and advertisers, guiding them to produce material that speaks to the conversations users are having (or that it appears that are about to have). Moreover, creative selection from among the advertiser's various creative pieces (ad copy library) can be automatically optimized and inserted into conversations.

In addition, advertisements can be placed in conversations that exist outside a company's “comfort zone,” given the right context. Furthermore, dynamic pricing of topic-linked ad inventory can be priced dynamically in anticipation of a predicted increase in conversational activity. Also, smarter ad arbitrage can be enabled, which can include, for example, buying inventory predictively around a conversation that is predicted to rise. Finally, the system can be connected to any number of conversation-promoting “levers” (i.e. highlighting a conversation on the home page, including it in daily entails, etc.) for the purpose of engendering more conversation around subject matter that is predicted to become important and active on the Web at large (and thus desired by advertisers). These and other related benefits are the result of the disclosed embodiment having richer models of the conversation, the influencer, and the marketing collateral, together with a unique method of matching them to one another.

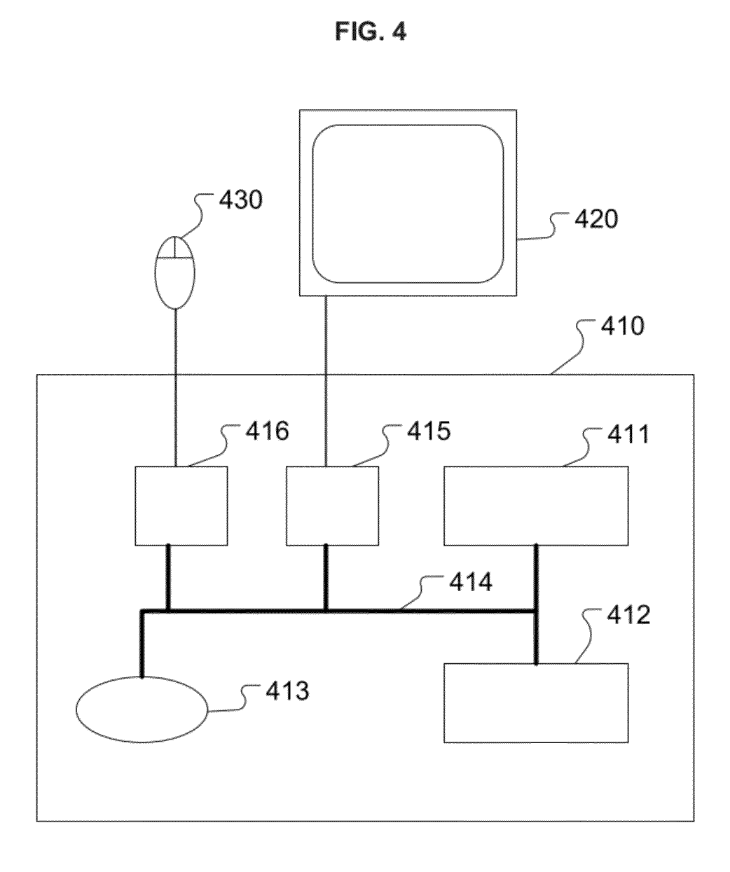

The embodiments described herein may be implemented with any suitable hardware and/or software configuration, including, for example, modules executed on computing devices such as computing device 410 of FIG. 4. Embodiments may, for example, execute modules corresponding to steps shown in the methods described herein. Of course, a single step may be performed by more than one module, a single module may perform more than one step, or any other logical division of steps of the methods described herein may be used to implement the processes as software executed on a computing device.

Computing device 410 has one or more processing device 411 designed to process instructions, for example computer readable instructions (i.e., code) stored on a storage device 413. By processing instructions, processing device 411 may perform the steps set forth in the methods described herein. Storage device 413 may be any type of storage device (e.g., an optical storage device, a magnetic storage device, a solid state storage device, etc.), for example a non-transitory storage device. Alternatively, instructions may be stored in remote storage devices, for example storage devices accessed over a network or the interact. Computing device 410 additionally has memory 412, an input controller 416, and an output controller 415. A bus 414 operatively couples components of computing device 410, including processor 411, memory 412, storage device 413, input controller 416, output controller 415, and any other devices (e.g., network controllers, sound controllers, etc.). Output controller 415 may be operatively coupled via a wired or wireless connection) to a display device 420 (e.g., a monitor, television, mobile device screen, touch-display, etc.) In such a fashion that output controller 415 can transform the display on display device 420 (e.g., in response to modules executed). Input controller 416 may be operatively coupled (e.g., via a wired or wireless connection) to input device 430 (e.g., mouse, keyboard, touch-pad, scroll-ball, touch-display, etc.) In such a fashion that input can be received from a user (e.g., a user may input with an input device 430 a dig ticket).

Of course, FIG. 4 illustrates computing device 410, display device 420, and input device 430 as separate devices for ease of identification only. Computing device 410, display device 420, and input device 430 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 410 may be one or more servers, for example a farm of networked servers, a clustered server environment, or a cloud network of computing devices.

While systems and methods are described herein by way of example and embodiments, those skilled in the art recognize that the disclosed embodiment is not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

Various embodiments of the disclosed embodiment have been disclosed herein. However, various modifications can be made without departing from the scope of the embodiments as defined by the appended claims and legal equivalents.

What is claimed is:

1. A computer-implemented method executed by one or more computing devices for placing content in conversations, the method comprising:
determining, by at least one of the one or more computing devices, intersecting data based on conversation data and marketing data, the marketing data being associated with content that is adapted for placement relative to one or more conversations; and
creating, by at least one of the one or more computing devices, a conversational model based on the intersecting data, the conversational model including data that is relevant to both the conversation data and the marketing data, wherein the conversational model is adapted to be used to place the content relative to at least one of the one or more conversations.

2. The method of claim 1, wherein the conversation data includes data from a webpage.

3. The method of claim 1, wherein at least one predictor influencer contributed to the conversation data.

4. The method of claim 1, further comprising identifying one or more conversation topics from within the conversation data.

5. The method of claim 4, further comprising identifying one or more aspects of at least one of the one or more conversation topics.

6. The method of claim 1, wherein the marketing data includes marketing collateral.

7. An apparatus for placing content in conversations, the apparatus comprising:
one or more processors; and
one or more memories operatively coupled to at least one of the one or more processors and storing instructions that, when executed by at least one of the one or more processors, cause at least one of the one or more processors to:
determine intersecting data based on conversation data and marketing data, the marketing data being associated with content that is adapted for placement relative to one or more conversations; and
create a conversational model based on the intersecting data, the conversational model including data that is relevant to both the conversation data and the marketing data, wherein the conversational model is adapted to be used to place the content relative to at least one of the one or more conversations.

8. The apparatus of claim 7, wherein the conversation data includes data from a webpage.

9. The apparatus of claim 7, wherein at least one predictor influencer contributed to the conversation data.

10. The apparatus of claim 7, further comprising instructions that, when executed by at least one of the one or more processors, cause at least one of the one or more processors to identify one or more conversation topics from within the conversation data.

11. The apparatus of claim 10, further comprising instructions that, when executed by at least one of the one or more processors, cause at least one of the one or more processors to identify one or more aspects of at least one of the one or more conversation topics.

12. The apparatus of claim 7, wherein the marketing data includes marketing collateral.

13. At least one non-transitory computer-readable medium storing computer-readable instructions that, when executed by one or more computing devices, place content in conversations, the instructions causing at least one of the one or more computing devices to:
determine intersecting data based on conversation data and marketing data, the marketing data being associated with content that is adapted for placement relative to one or more conversations; and
create a conversational model based on the intersecting data, the conversational model including data that is relevant to both the conversation data and the marketing data, wherein the conversational model is adapted to be used to place the content relative to at least one of the one or more conversations.

14. The computer-readable medium of claim 13, wherein the conversation data includes data from a webpage.

15. The computer-readable medium of claim 13, wherein at least one predictor influencer contributed to the conversation data.

16. The computer-readable medium of claim 13, further comprising instructions that, when executed by at least one of the one or more processors, cause at least one of the one or more processors to identify one or more conversation topics from within the conversation data.

17. The computer-readable medium of claim 16, further comprising instructions that, when executed by at least one of the one or more processors, cause at least one of the one or more processors to identify one or more aspects of at least one of the one or more conversation topics.

18. The computer-readable medium of claim 13, wherein the marketing data includes marketing collateral.

19. A computer-implemented method executed by one or more computing devices for placing content on a webpage, the method comprising:
creating, by at least one of the one or more computing devices, one or more conversation tags corresponding to a conversation on a webpage;
determining, by at least one of the one or more computing devices, content for placement relative to the conversation based at least one of the conversation tags; and
placing, by at least one of the one or more computing devices, the content on the webpage relative to the conversation.

20. The method of claim 19, further comprising analyzing the conversation and another conversation.

21. The method of claim 19, wherein the content is associated with at least one of a promoted comment, an advertisement, and a widget.

22. The method of claim 19, further comprising transmitting information related to at least one of the conversation, the conversation tags, the content, and the webpage.

23. The method of claim 19, wherein the content corresponds to marketing collateral.

24. The method of claim 19, wherein the content corresponds to one or more products or services.
